(19) United States
(12) Patent Application Publication
(10) Pub. No.: US 2014/0037971 A1
(43) Pub. Date: Feb. 6, 2014

(54) REINFORCED ARTICLES AND METHODS OF MAKING THE SAME

(71) Applicant: Rupak Das, Greenville, SC (US)

(72) Inventor: Rupak Das, Greenville, SC (US)

(73) Assignee: GENERAL ELECTRIC COMPANY, Schenectady, NY (US)

(21) Appl. No.: 13/566,698

(22) Filed: Aug. 3, 2012

(51) Int. Cl. F02C 7/30; B32B 18/00; F01D 5/14; F23D 14/48; B32B 37/00; F01D 25/24; B82Y 30/00

(52) U.S. Cl. 428/448; 156/60; 428/446; 415/182.1; 416/223 R; 239/589; 977/778

(57) ABSTRACT

An article comprising a substrate; a bond layer disposed on the substrate; a first reinforcing layer disposed on the bond layer, the first reinforcing layer comprising a plurality of nanoparticles; and a protective layer disposed on the first reinforcing layer, wherein the first reinforcing layer reduces formation of thermally grown oxide generated at the bond layer, and methods of making the same.

### BACKGROUND OF THE INVENTION

The subject matter disclosed herein relates to reinforced articles, such as gas turbine engine components, and more particularly to reinforced articles which are creep resistant, and methods of making the same.

Gas turbine engines accelerate gases, forcing the gases into a combustion chamber where heat is added to increase the volume of the gases. The expanded gases are then directed toward a turbine to extract the energy generated by the expanded gases. In order to endure the high temperatures and extreme operating conditions in gas turbine engines, gas turbine engine components, such as turbine blades, are fabricated from metal, ceramic or ceramic matrix composite materials.

Environmental barrier coatings are applied to the surface of gas turbine engine components to provide added protection and to thermally insulate the gas turbine engine components during operation of the gas turbine engine at high temperatures. An environmental barrier coating is at least one protective layer which is applied to a component, or a substrate, using a bond layer. The protective layer is a ceramic material and can also include multiple layers. The hot gas environment in gas turbine engines results in oxidation of the bond layer and formation of a thermally grown oxide layer at the interface between the bond layer and the protective layer.

The thermally grown oxide layer creeps in the environmental barrier coating as a result of shear stress due to, for example, centrifugal load or mismatch of thermal expansion with the outer protective layers of the environmental barrier coating. Creep of the thermally grown oxide layer causes cracking or deformation in the outer protective layers of the environmental barrier coatings and/or substrate and/or reduces the overall lifetime of the component.

It is therefore desirable to provide reinforced articles having improved creep resistance, oxidation resistance and/or temperature resistance and methods of making the same, which solve one or more of the aforementioned problems.

### BRIEF DESCRIPTION OF THE INVENTION

According to one aspect of the invention, an article comprises a substrate; a bond layer disposed on the substrate; a first reinforcing layer disposed on the bond layer, the first reinforcing layer comprising a plurality of nanoparticles; and a protective layer disposed on the first reinforcing layer, wherein the first reinforcing layer reduces/hinders formation of thermally grown oxide generated at the bond layer.

According to another aspect of the invention, a method comprises disposing a bond layer on a substrate; disposing a first reinforcing layer on the bond layer, the first reinforcing layer comprising a plurality of nanoparticles; and disposing a protective layer on the first reinforcing layer, wherein the first reinforcing layer reduces formation of thermally grown oxide generated at the bond layer.

These and other advantages and features will become more apparent from the following description taken together in conjunction with the accompanying drawings.

### BRIEF DESCRIPTION OF THE DRAWINGS

The subject matter, which is regarded as the invention, is particularly pointed out and distinctly claimed in the claims at the conclusion of the specification.

The foregoing and other features, and advantages of the invention are apparent from the following detailed description taken in conjunction with the accompanying drawings in which:

FIG. 1 is a partial cross-sectional view of an article; and

FIG. 2 is a partial cross-sectional view of another article.

The detailed description explains embodiments of the invention, together with advantages and features, by way of example with reference to the drawings.

### DETAILED DESCRIPTION OF THE INVENTION

Embodiments described herein generally relate to reinforced particles and methods of making the same. A reinforcing layer is provided for use in conjunction with a substrate, a bond layer and a protective layer.

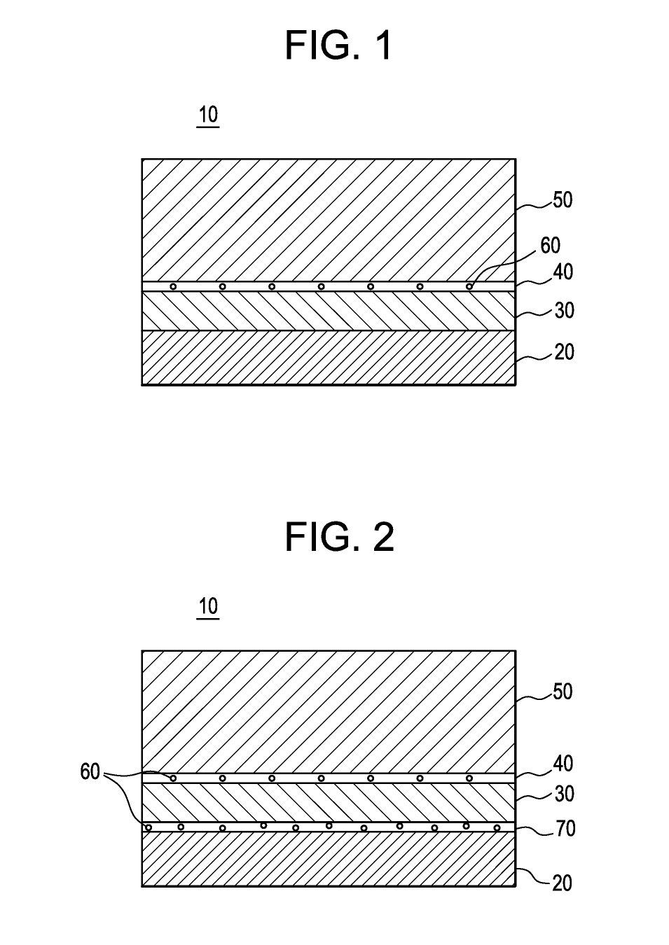

Referring to FIG. 1, an article 10 comprises a substrate 20. A bond layer 30 is disposed on the substrate 20. A first reinforcing layer 40 is disposed on the bond layer 30. A protective layer 50 is disposed on the first reinforcing layer 40.

The substrate 20 is a metal, ceramic, or ceramic matrix composite (CMC) material. In one embodiment, the substrate 20 is gas turbine engine component. In another embodiment, the substrate is a turbine blade, vane, shroud, liner, combustor, transition piece, rotor component, exhaust flap, seal or fuel nozzle. In yet another embodiment, the substrate 20 is a turbine blade formed using a CMC material.

The bond layer 30 assists in bonding the protective layer 30 to the substrate 20. In one embodiment, the bond layer 30 comprises silicon.

The protective layer 50 protects the substrate from the effects of environmental conditions to which the article 10 is subjected during operation such as hot gas, water vapor and/or oxygen. The protective layer 30 is any material suitable to protect the substrate 20 from being contacted with hot gas, water vapor and/or oxygen when the article 10 is in operation. In one embodiment, the protective layer 50 comprises a ceramic material. In another embodiment, the protective layer 50 comprises silicon.

In one embodiment, the protective layer 50 comprises a single layer. In another embodiment, the protective layer 50 comprises multiple layers of various materials. In yet another embodiment, the protective layer is an environmental barrier coating (EBC) comprising multiple layers of various materials.

The protective layer 50 is disposed on the first reinforcing layer 40 using any suitable method, including but not limited to, atmospheric plasma spray (APS), chemical vapor deposition (CVD), plasma enhanced CVD (PECVD), dip coating, spin coating and electro-phoretic deposition (EPD).

During the operation of the article 10 at high temperatures, exposure to hot gases, water vapor and/or oxygen results in oxidation of the bond layer 30. Upon melting and oxidation, the bond layer 30 forms a viscous fluid layer (not shown), such as a viscous glass layer. The viscous fluid layer comprises thermally grown oxide (TGO). The viscous fluid layer moves, or slides, under shear stress caused by centrifugal load applied to the article 10 during operation and a mismatch of the coefficients of thermal expansion with the protective layer 50. This phenomenon is referred to as “creep”. The creep of the protective layer 50 results in cracking and/or reduces the overall lifetime of the component.

The first reinforcing layer 40 reduces or inhibits the formation of thermally grown oxide generated at the bond layer 30. The first reinforcing layer 40 comprises a plurality of nanoparticles 60. In one embodiment, the nanoparticles 60 comprise nanotubes, nanowires or a combination comprising at least one of the foregoing. In another embodiment, the nanoparticles 60 comprise silicon. In yet another embodiment, the nanoparticles 60 comprise silicon carbide. In still yet another embodiment, the nanoparticles 60 comprise silicon carbide nanowires.

The average diameter of the nanoparticles 60 is from about 1 nm to about 10 μm. In one embodiment, the average diameter of the nanoparticles 60 is from about 1 nm to about 1 μm. In another embodiment, the average diameter of the nanoparticles 60 is from about 10 nm to about 100 nm. In yet another embodiment, the average diameter of the nanoparticles 60 is from about 10 nm to about 50 nm.

The first reinforcing layer 40 is disposed on the bond layer 30 using any of the same methods used to apply the protective layer 50. In one embodiment, the first reinforcing layer 40 is applied using spin coating. In another embodiment, the first reinforcing layer 40 is a continuous layer which is continuous with a surface of the bond layer 30.

The nanoparticles 60 form a network in the first reinforcing layer 40. The resulting network is superhydrophobic, trapping air and hot gas within pores formed in the network. The nano-porous transport of hot gas results in a mean free path which is less than the diameter of a passage, decreasing the surface free energy of the first reinforcing layer 40. Contact between hot gas and the bond layer 30 is reduced or inhibited, thereby reducing or inhibiting the amount of thermally grown oxide generated at the bond layer 30. The first reinforcing layer 40 also assists in bonding, or adhering, the bond layer 30 to the protective layer 50.

The network of particles 60 is a mesh form, 3D woven form, unidirectional form, or a combination comprising at least one of the foregoing. The network of particles 60 causes the first reinforcing layer 40 to have a rough surface morphology, changing the water contact angle of the first reinforcing angle layer 40.

Referring to FIG. 2, in one embodiment, the article 10 further comprises a second reinforcing layer 70. The second reinforcing layer 70 is disposed on the substrate 20, between the substrate 20 and the bond layer 30. The second reinforcing layer 70 comprises the same materials, is disposed using the same methods, and has the same properties as described above with regard to the first reinforcing layer 40. In one embodiment, the second reinforcing layer 70 comprises the same materials, is disposed using the same method and has the same properties as the first reinforcing layer 40. In another embodiment, the second reinforcing layer 70 comprises different materials and/or is disposed on the substrate 20 using a different method and/or has different properties than the first reinforcing layer 40. The second reinforcing layer 70, in conjunction with the bond layer 30, assists in bonding the protective layer 50 to the substrate 20.

The thickness of the first reinforcing layer 40 and/or the second reinforcing layer 70 is from about 1 nm to about 100 μm. In another embodiment, the thickness of the first reinforcing layer 40 and/or the second reinforcing layer 70 is from about 1 nm to about 50 μm. In yet another embodiment, the thickness of the first reinforcing layer 40 and/or the second reinforcing layer 70 is from about 1 nm to about 10 μm. In still yet another embodiment, the thickness of the first reinforcing layer 40 and/or the second reinforcing layer 70 is uniform or substantially uniform.

The first reinforcing layer 40 and/or the second reinforcing layer 70 provide improved oxidation resistance, creep resistance and/or temperature resistance of equal to or greater than 2400° F., thereby improving the performance and overall lifetime of the article 10.

In one embodiment, a method comprises disposing the bond layer 30 on a substrate 20, disposing a first reinforcing layer 40 on the bond layer 30 and disposing a protective layer 50 on the first reinforcing layer 40. In another embodiment, the method further comprises disposing a second reinforcing layer 70 between the substrate 20 and the bond layer 30.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An article comprising:
a substrate;
a bond layer disposed on the substrate;
a first reinforcing layer disposed on the bond layer, the first reinforcing layer comprising a plurality of nanoparticles; and
a protective layer disposed on the first reinforcing layer,
wherein the first reinforcing layer reduces formation of thermally grown oxide generated at the bond layer.

2. The article of claim 1, wherein the substrate comprises a ceramic or a ceramic matrix composite.

3. The article of claim 1, wherein the bond layer comprises silicon.

4. The article of claim 1, wherein the plurality of nanoparticles of the first reinforcing layer comprise silicon carbide.

5. The article of claim 1, wherein the plurality of nanoparticles of the first reinforcing layer comprise nanowires, nanotubes or a combination comprising at least one of the foregoing.

6. The article of claim 1, wherein a second reinforcing layer is disposed between the substrate and the bond layer, the second reinforcing layer comprising a plurality of nanoparticles, wherein the second reinforcing layer reduces formation of thermally grown oxide generated at the bond layer.

7. The article of claim 1, wherein the protective layer comprises at least two layers.

8. The article of claim 1, wherein the article is a gas turbine engine component.

9. The article of claim 1, wherein the substrate is a turbine blade, vane, shroud, liner, combustor, transition piece, rotor component, exhaust flap, seal or fuel nozzle.

10. The article of claim 1, wherein the protective layer is an environmental barrier coating.

11. A method comprising:
disposing a bond layer on a substrate;
disposing a first reinforcing layer on the bond layer, the first
reinforcing layer comprising a plurality of nanoparticles; and
disposing a protective layer on the first reinforcing layer,
wherein the first reinforcing layer reduces formation of thermally grown oxide generated at the bond layer.

12. The method of claim 11, wherein the substrate comprises a ceramic or a ceramic matrix composite.

13. The method of claim 11, wherein the bond layer comprises silicon.

14. The method of claim 11, wherein the plurality of nanoparticles of the first reinforcing layer comprises silicon carbide.

15. The method of claim 11, wherein the plurality of nanoparticles of the first reinforcing layer comprises nanowires, nanotubes or a combination comprising at least one of the foregoing.

16. The method of claim 11, further comprising disposing a second reinforcing layer between the substrate and the bond layer, the second reinforcing layer comprising a plurality of nanoparticles, wherein the second reinforcing layer reduces formation of thermally grown oxide generated at the bond layer.

17. The method of claim 11, wherein the protective layer comprises at least two layers.

18. The method of claim 11, wherein the substrate is a gas turbine engine component.

19. The method of claim 11, wherein the substrate is a turbine blade, vane, shroud, liner, combustor, transition piece, rotor component, exhaust flap, seal or fuel nozzle.

20. The method of claim 11, wherein the protective layer is an environmental barrier coating.
